(19) United States
(12) Patent Application Publication
(10) Pub. No.: US 2013/0055860 A1
(43) Pub. Date: Mar. 7, 2013

(54) ADJUSTABLE HANDLE ASSEMBLY FOR A HAND-HELD TOOL

(71) Applicant: Justin Daniel French, Nowata, OK (US)

(72) Inventor: Justin Daniel French, Nowata, OK (US)

(21) Appl. No.: 13/225,650

(22) Filed: Sep. 6, 2011

(51) Int. Cl. B25F 5/02

(52) U.S. Cl. 81/489

(57) ABSTRACT

Various aspects may provide for an adjustable handle assembly for a hand-held tool. The assembly may comprise a guide track connectable to a hand-held tool. The guide track may be selectively connectable to the hand-held tool at a plurality of angular orientations. The guide track may extend around at least a portion of the hand-held tool. The assembly may comprise a handle assembly configured to slidingly associate with the guide track in such a way that the handle is slideably along the guide track when the handle is in an unlocked configuration and prevented from sliding along the guide track when the handle is in a locked configuration. The guide track may be sized and shaped to extend around a head of the hand-held tool.

### BACKGROUND

1. Technical Field

The present disclosure generally relates to an adjustable handle assembly for a hand-held tool. More particularly, but not by way of limitation, the present disclosure relates to an adjustable handle assembly for a hand-held tool that permits a user to readily adjust the position and/or orientation of the handle with respect to the hand-held tool.

2. Description of Related Art

Hand-held tools can be found on virtually every construction site, pipeline job, garage, as well as in most homes. They can be used in industry, in construction, and around the house for driving, drilling, cutting, shaping, sanding, grinding, polishing, painting, heating, etc. Exemplary hand-held tools include a drill, an angle grinder, various types of saws, a router, a sander, an impact wrench, a floor sander, a rotary tool, and the like. Further, hand-held tools can be powered by a variety of means, e.g., electricity, air, fluid, etc.

Hand-held tools generally include a housing covering the internal components. The housing may cover and protect an internal motor which operates to drive the tool, e.g., a motor spinning the arbor of a drill or an angle grinder. Generally, the housing is sized and shaped in such a manner as to form a grip or handle on the housing to thereby permit the user to grip or hold the hand-held tool during operation. Further, some hand-held tools are equipped with a threaded aperture in a head (e.g., the functional end of the tool) and a second handle which can be connected in a fixed manner via the threaded aperture to provide the user with a second handle or grip for the tool. However, the commonly available second handle configurations provide limited usability of the tool and often require the operator to assume uncomfortable and even dangerous positions to use the tool in certain conditions.

That is, as is understood in the art, the handling capability provided by the housing grip and second attachable handle of the currently existing hand-held tools may not be sufficient to effectively operate the tool. For instance, in the case of an angle grinder, a user may need to operate the grinder at a plurality of differing angles and/or orientations to be able to properly reach locations needing grinding in an odd shaped structures (e.g., inside large circular pipes). Such variable angle usability using existing hand-held tool handle designs would require the user to shift or position his body in complicated and even dangerous positions to be able to reach every required grinding position. Therefore, current hand-held tool designs do not permit such varying operational angles in a manner sufficient to permit full utilization of the tool.

Therefore, it is an object of the present disclosure to provide an adjustable handle assembly for a hand-held tool that permits a user of the tool to readily adjust the angle and orientation of an adjustable handle assembly to provide for improved use of the tool in any number of differing angles. It is another object of the present disclosure to provide for an adjustable handle assembly that is relatively simple and easy to operate by the user and which can also be used on a variety of differing hand-held tools.

### SUMMARY OF THE INVENTION

Various aspects may provide for an adjustable handle assembly for a hand-held tool. The assembly may comprise a guide track connectable to a hand-held tool. The guide track may extend around at least a portion of the hand-held tool. The assembly may also comprise a handle assembly configured to slidingly associate with the guide track in such a way that the handle is slideably along the guide track when the handle is in an unlocked configuration and prevented from sliding along the guide track when the handle is in a locked configuration. The guide track may be sized and shaped to extend around a head of the hand-held tool.

The guide track may further comprise a channel formed therein and having a channel length. The handle assembly may further comprise a locking mechanism configured to extend through the channel to thereby compressively connect the handle assembly to the guide track. The locking mechanism may be configured to slide within the channel and being selectively fixable to any position along the channel length such that the handle assembly can be securely positioned at any angular position around the head of the hand-held tool. The locking mechanism may comprise a bolt connected to a handle of the handle assembly and extending through the channel and a nut threadably connected to the bolt to thereby compressively connect the movable handle assembly to the guide track. The locking mechanism may comprise a threaded insert inside a handle of the handle assembly and a bolt extending through the channel and threadably connected to the threaded insert to thereby compressively connect the movable handle assembly to the guide track.

The guide track may be connectable to the hand-held tool using a mount. The mount may comprise a mount plate integral to the guide track, the mount plate including a first aperture and a plurality of second apertures positioned at predetermined angles around the first aperture. The mount may also comprise a mount base threadably connectable to the hand-held tool and having a mount face, the mount base comprising a plurality of extrusions extending from the mount face at predetermined angles, wherein the extrusions and the second apertures are correspondingly sized, shaped, and oriented to permit the mount to be connected to the mount base at a plurality of predetermined angular orientations with respect to the hand-held tool.

The guide track may be formed using square tubing comprising a channel formed in a substantially outward facing side of the square tubing with respect to the hand-held tool. The guide track may be formed using a bar and a channel is formed within the bar.

Various aspects may also provide for an adjustable handle assembly for a hand-held tool. The assembly may comprise a guide track configured to selectively connect to a hand-held tool at a plurality of predetermined angular orientations. The guide track may extend around at least a portion of the hand-held tool. The assembly may also comprise a handle assembly configured to slidingly associate with the guide track in such a way that the handle is slideably along the guide track when the handle is in an unlocked configuration and prevented from sliding along the guide track when the handle is in a locked configuration. The guide track may be sized and shaped to extend around a head of a hand-held tool.

Certain aspects may also provide for wherein the guide track comprises a channel formed therein and having a channel length. The handle assembly may further comprise a locking mechanism configured to extend through the channel to thereby compressively connect the handle assembly to the guide track. The locking mechanism may be configured to slide within the channel and being selectively fixable to any position along the channel length such that the handle assembly can be securely positioned at any angular position around the head of the hand-held tool.

The locking mechanism may comprise a bolt connected to a handle of the handle assembly and extending through the channel and a nut threadably connected to the bolt to thereby compressively connect the movable handle assembly to the guide track. The locking mechanism may comprise a threaded insert inside a handle of the handle assembly and a bolt extending through the channel and threadably connected to the threaded insert to thereby compressively connect the movable handle assembly to the guide track. The guide track may be selectively connectable to the hand-held tool using a mount. The mount may comprise a mount plate integral to the guide track, the mount plate including a first aperture and a plurality of second apertures positioned at predetermined angles around the first aperture and a mount base threadably connectable to the hand-held tool and having a mount face, the mount base comprising a plurality of extrusions extending from the mount face at predetermined angles, wherein the extrusions and the second apertures are correspondingly sized, shaped, and oriented to permit the mount to be connected to the mount base at a plurality of predetermined angular orientations with respect to the hand-held tool.

The guide track may he formed using square tubing with the channel formed in a substantially outward facing side of the square tubing with respect to the hand-held tool.

And lastly, various aspects may also provide for a hand-held tool. The hand-held tool may comprise a tool housing comprising a head, an adjustable handle assembly connected to the tool housing. The adjustable handle assembly may comprise a guide track extending around at least a portion of the hand-held tool and a handle assembly configured to slidingly associate with the guide track in such a way that the handle assembly is selectively fixable to any position along the guide track such that the movable handle assembly can be securely oriented at any angular position around the head of the tool housing.

These, as well as other advantages of the present disclosure will be apparent to those having ordinary skill in the art with the provided disclosure, accompanying figures, and appended claims.

### BRIEF DESCRIPTION OF THE DRAWINGS

FIG. 1 is a perspective view of a hand-held tool including an adjustable handle assembly constructed in accordance with the present disclosure.

FIG. 2 is a perspective view showing in greater detail certain aspects of the adjustable handle assembly constructed in accordance with the present disclosure.

FIG. 3 is a top plan view of the hand-held tool having the adjustable handle assembly shown in FIG. 1 which illustrates the adjustable handle assembly in a plurality of positions, in accordance with the present disclosure.

FIG. 4 is a cross-sectional side plan view illustrating an alternate embodiment of the guide track of the adjustable handle assembly constructed in accordance with the present disclosure.

FIG. 5 is a perspective view illustrating an alternate embodiment of the mount of the adjustable handle assembly constructed in accordance with the present disclosure.

FIG. 6 is a perspective view illustrating the alternate embodiment shown in FIG. 5 and being used on a hand-held tool, in accordance with the present disclosure.

### DETAILED DESCRIPTION OF THE INVENTION

Before explaining the presently disclosed and claimed inventive concept(s) in detail by way of exemplary embodiments, drawings, and appended claims, it is to be understood that the present disclosure is not limited in its application to the details of construction and the arrangement of the components set forth in the following description or illustrated in the drawings. The present disclosure is capable of other embodiments or of being practiced or carried out in various ways. As such, the language used herein is intended to be given the broadest possible scope and meaning; and the embodiments are meant to be exemplary--not exhaustive. It is to be understood that the phraseology and terminology employed herein is for the purpose of description and should not be regarded as limiting. Unless otherwise required by context, singular terms may include pluralities and plural terms may include the singular.

It is to be understood that the term hand-held tool as used herein may generally refer to any tool which is designed to be held by a user during operation. Such hand-held tools may be powered by electricity, air (e.g., pneumatic hand-held tools), hydraulic, and the like. Exemplary tools include, but are not limited to, a drill, an angle grinder, various types of saws, a router, a sander, an impact wrench, a floor sander, a rotary tool, and the like. Although the discussion below and the figures attached hereto generally refer to an angle grinder being utilized with the presently disclosed adjustable handle assembly, it is to be understood that such is provided as an example only and the present disclosure is not limited in its application to an angle grinder, i.e., any other hand-held tool can be used with the presently disclosed inventive concept(s). More particularly, the adjustable handle assembly can be connected to and usable with any number or variety of hand-held tools that are known in the art.

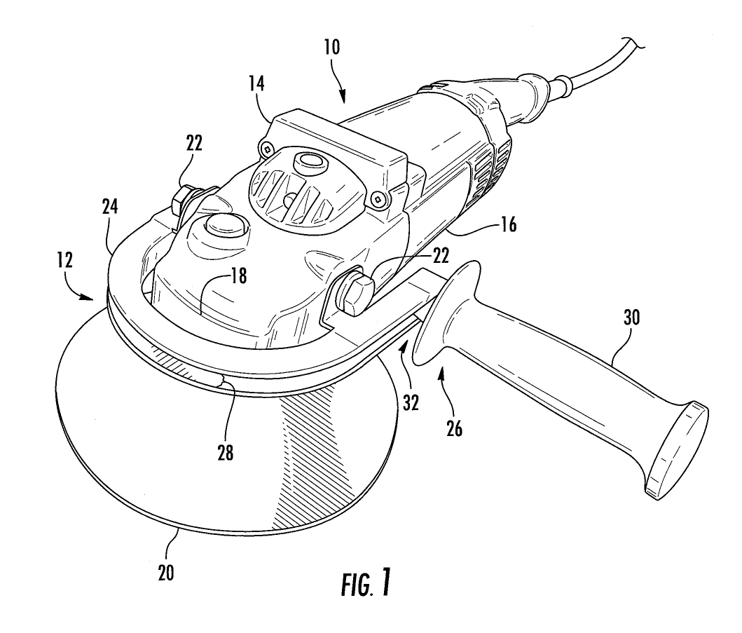

Referring now to the figures, and in particular FIG. 1, shown therein is an exemplary hand-held tool 10 having an adjustable handle assembly 12 connected thereto, in accordance with the present disclosure. The hand-held tool 10 comprises a housing 14 that generally covers and protects the internal components of the hand-held tool 10, e.g., the motor, gears, wiring, etc. The housing 14 may be configured to thereby define a housing grip 16. The housing grip 16 permits the user to hold the tool 10 and may also permit the user to activate a switch (not shown) which starts and stops operation of the hand-held tool 10. The housing 14 may also be configured so as to define a head 18 of the hand-held tool 10. The head 18 may generally refer to the front or operational end of the hand-held tool 10. In the tool 10 shown in FIG. 1, the head 18 generally refers to the portion of the housing 14 that covers the gears, arbor, etc., which is connected to, in this case, a grinding disc 20. As would be further understood, the head 18 may be positioned a distance from the housing grip 16 of the hand-held tool 10.

The housing 14 may further include one or more mechanisms designed to permit the adjustable handle assembly 12 to be attached or otherwise connected to the hand-held tool 10. The adjustably handle assembly 12 may be removably or selectively connected to the hand-held tool 10 such that a user of the tool 10 can readily connect or disconnect the assembly 12 to the tool 10 as needed. In the exemplary tool 10 shown in FIG. 1, two mechanisms (not visible) are included and embodied as threaded inserts or apertures in the housing 14 at or near the head 18 of the hand-held tool 10. More particularly, but not by way of limitation, in the exemplary tool 10 illustrated in FIG. 1, the housing 14 includes two threaded inserts or apertures (not visible) which permit the adjustable handle assembly 12 to be connected to the hand-held tool 10 using two bolts 22. Although the tool 10 illustrated in FIG. 1 includes threaded inserts permitting the adjustable handle assembly 12 to be connected thereto using the bolts 22, it is considered within the scope of the present disclosure that the tool 10 may include other mechanisms configured to permit the adjustable handle assembly 12 to be connected thereto. Exemplary mechanisms may include, a threaded insert/bolt configuration, a quick release pin configuration (e.g., locking pin), a quarter-turn mechanism, compression fitting, and the like.

Further, the hand-held tool 10 may include one, two, or more mechanisms permitting the adjustable handle assembly 12 to be connected thereto. The adjustable handle assembly 12 can be configured to include the appropriate mechanisms (e.g., the mount discussed below), which may be sized and spaced so as to align with the corresponding mechanisms of the hand-held tool 10. The adjustable handle assembly 12 may be configured in a variety of manners to as to be connectable to a variety of differing hand-held tools 10 having differing connection mechanisms.

The adjustable handle assembly 12 may comprise a guide track 24 and a handle assembly 26. Generally, the guide track 24 is connectable to the hand-held tool 10 (e.g., using any of the above described mechanisms) and extends around at least a portion of the hand-held tool 10. The guide track 24 may extend around at least a portion of the head 18 of the hand-held tool 10. The guide track 24 may be sized and shaped to extend around the head 18 of the hand-held tool 10. The guide track 24 may be sized and shaped so as to conform to the contour of at least a portion of the head 18 of the hand-held tool 10. The guide track 24 may extend around the head 18 of the hand-held tool 10 at a predetermined offset distance from the head 18, i.e., the guide track 24 may not come in contact with the head 18 (other than as connected to the tool 10 and described herein).

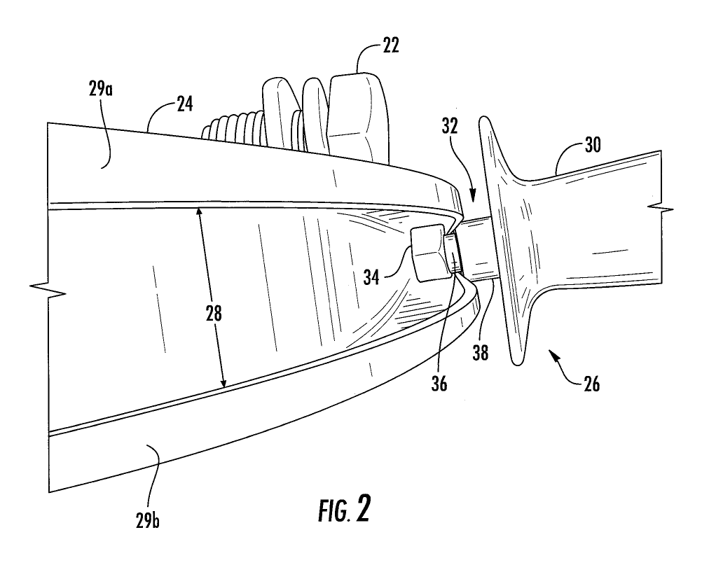

The guide track 22 may further comprise a channel 28 formed therein and extending at least a portion of the distance around the length of the guide track 22. The channel 28 may extend around the guide track 22 so as to thereby define a channel length. For example, as illustrated in FIG. 1 and illustrated more clearly in FIG. 2, the channel 28 may be formed or provided within the guide track 24 so as to define an opening or groove. The channel 28 formed in the guide track 24 defines a first and a second member 29a and 29b (see FIG. 2), respectively. The channel 28 may be sized and/or shaped so as to permit the handle assembly to slidingly associate with the guide track 24. That is, the handle assembly 26 may slide within the channel 28 of the guide track 24 so as to be positioned at a plurality positions along a length of the guide track 24 and therefore, by extension, around the head 18 of the hand-held tool 10. For example, as viewed from the rear of the tool 10 towards the head 18 and extending along a longitudinal axis of the tool 10, the handle assembly 26 may be slidingly associated with the guide track 24 so as to slide from a left side of the head 18 to a front of the head 18 and on around to a right side of the head 18, as well as any number of positions therebetween, thereby providing an unlimited variety of angular positions for the handle assembly 26 to be positioned around the guide track 24. The handle assembly 26 may be configured to slidingly associate with the guide track 24 in such a way that the handle assembly 24 is slideably along the guide track 24 when the handle assembly 26 is in an unlocked configuration and prevented from sliding along the guide track 24 when the handle assembly 26 is in a locked configuration.

The guide track 24 may be formed using a variety of materials including metals, composite metals, composite materials and the like. Exemplary materials include high strength steel, carbon steel, carbon composites, etc. As would be understood in the art, the selection of materials used to form the guide track 24 may depend on such factors as the particular hand-held tool 10 the adjustable handle assembly 12 will be connected to, the amount of anticipated force to be applied to the assembly 12, and the like.

The guide track 24 may be formed using square tubing, such as illustrated in FIGS. 1-3, 5, and 6. When embodied as square tubing, the guide track 24 may comprise the channel 28 formed in a substantially outward facing side of the square tubing with respect to the hand-held tool 10. The guide track may further be formed using a bar wherein the channel 28 is formed within the bar.

The channel 28 may be formed in the guide track 24 during construction or forming of the guide track 24. The channel 28 may be formed in the guide track 24 post-construction or formation. The channel 28 may be formed in the guide track 24 by cutting, ablation, and the like.

The handle assembly 26 may comprise a handle 30 and a locking mechanism 32. The handle 30 may be sized and shaped so as to permit the user to grip the handle 30 of the adjustable handle assembly 12 during operation. The locking mechanism 32 may be configured to extend through the channel 28 of the guide track 24 to thereby compressively connect the handle assembly 26 to the guide track 24. The locking mechanism 32 may be configured to slide within the channel 28. The locking mechanism 32 may be selectively fixable to any position along the channel length of the channel 28 such that the handle assembly 26 may be securely positioned at any angular position around the head of the hand-held tool. The locking mechanism 32 may be configured to slidingly associate the handle assembly 26 with the guide track 24 in such a way that the handle 30 (via the handle assembly 26) is slideably along the guide track 24 when the handle is in an unlocked configuration and prevented from sliding along the guide track when the handle is in a locked configuration.

The locking mechanism 32 may be configured to compressively connect the handle assembly 26 to the guide track 24 to thereby form a locked configuration. That is, the locking mechanism 32 may be configured such that, though simple and rapid manipulation by the user, it can be readily converted from a locked configuration, which prevents the handle assembly 26 from sliding within the channel 28, to an unlocked configuration, wherein the assembly 26 is free to slide within the channel 28. The simple and rapid manipulation operates to permit the user to easily change the position of the handle assembly 26 along the length of the guide track to thereby effectively grip the tool 10 at a variety of differing angles.

Referring now to FIG. 2, illustrated therein is an exemplary locking mechanism 32 constructed in accordance with the present disclosure. As shown therein, the locking mechanism 32 may comprise a nut 34 connected to the handle 30 via a rod 36. The rod 36 may further include threads extending along at least a portion of its length wherein the nut 34 can be threadably connected thereto. The handle 30 may comprise a threaded insert (not shown) which permits the rod 36 to thereby be threadably connected therein. The handle 30 may further comprise a stepped section 38 making direct contact with the guide track 24. The rod 36 extending through the channel 28 and being threadably connected to the handle 30 and the nut 34 permits the locking mechanism 32 to compressively connect the movable handle assembly 12 to the guide track 24. For instance, the first and second members 29a and 29b can be compressed between the nut 34 and the handle 30 or stepped section 38 by, for example, a user turning the handle 30 a first direction (e.g., clockwise) to thereby thread the handle 30 down onto the rod 36 to thereby form a locked configuration for the handle assembly 26. Conversly, the user can turn the handle a second direction (e.g., counter-clockwise) to thereby thread the handle 30 away from the nut 34 to release the compression on the first and second members 29a and 29b to thereby form an unlocked configuration.

Further, the nut 34 sliding within the guide track 24 may be sized and/or shaped to prevent it from turning inside the guide track 24 when the handle 30 is being turned by a user of the tool 10. For example, the nut 34 may be prevented from turning inside the guide track 24 by an upper and lower surfaces of the nut being in or near contact with an inside surface of the guide track 24. Alternatively, the nut 34 and the rod 36 can be integral, e.g., a bolt, which can be threadably connected to the handle 30 to thereby compressively connect the handle assembly 26 to the guide track 24. That is, the bolt head can be sized and/or shaped to be inserted into and slide (without turning) within the guide track 24 wherein the threaded shaft of the bolt would extend through the channel 28 to be threadably connected to the handle 30.

Although the locking mechanism 32 is described and shown herein as using a threaded rod 36 (or bolt) which, when operated by the user, compressively connects the handle assembly 26 to the guide track 24, it is to be understood that other mechanisms can also be used within the locking mechanism 32 to thereby apply the compressive force. For instance, the locking mechanism can be implemented using a compression fitting, a quick release mechanism, and the like. Therefore, the locking mechanism 32 is not limited to the threaded mechanism discussed above.

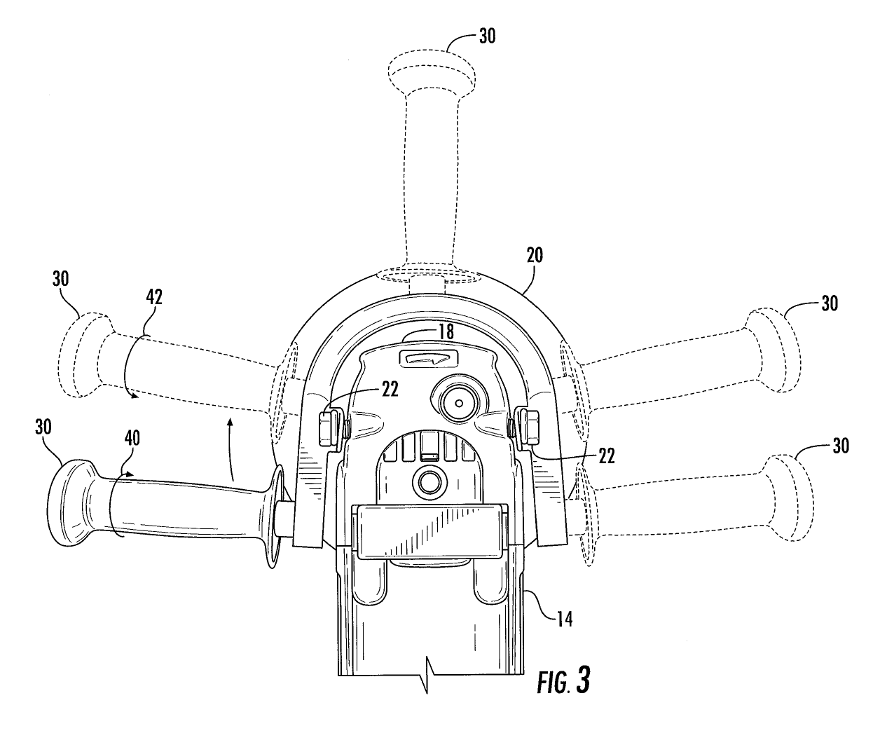

Referring now to FIG. 3, shown therein is an illustration of the adjustable handle assembly 26 in a plurality of positions, in accordance with the present disclosure. In operation, the user may grip the handle 30 of the handle assembly and, for instance, turn the handle a first direction 40 to thereby place the handle assembly in an unlocked configuration. That is, turning the handle the first direction 40 may release the compressive connection between the handle assembly 26 and the guide track 24. For example, turning the handle 30 the first direction 40 may release the compressive grip on the first and second members 29a and 29b exerted by the nut 34 and the handle 30 or stepped section 38. The user may then slide the handle assembly 26 within the guide track 24 to a second position. The user may then turn the handle 30 a second direction 42 which may place the handle assembly 26 in a locked configuration. That is, turning the handle the second direction 42 may operate to compressively connect the handle assembly 26 to the guide track 24. For example, turning the handle 30 the second direction 42 may increase the compressive grip on the first and second members 29a and 29b exerted by the nut 34 and the handle 30 or stepped section 38. The user may then repeat this any number of times and as needed to slide the handle assembly 26 along the length of the guide track 24 so as to thereby position the handle 30 at any direction around the head 18 of the hand-held tool 10. The first and second directions 40 and 42 may operate to transition the handle assembly between the locked and unlocked configuration via the threaded connections discussed above.

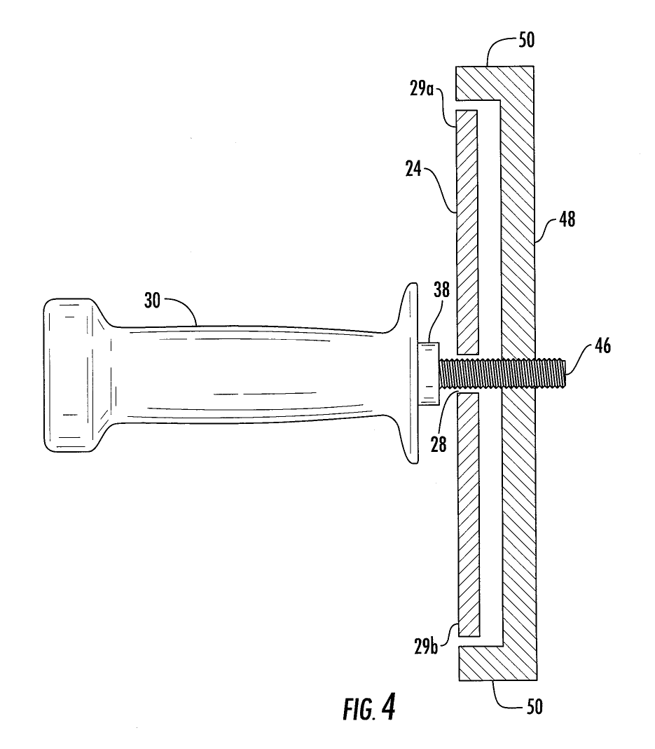

Turning now to FIG. 4, shown therein is a cross-sectional side plan view illustrating an alternate embodiment of the guide track 24 constructed in accordance with the present disclosure. As mentioned above, the guide track 24 may be implemented as a bar with the channel 28 formed therein. An exemplary implementation of the guide track 24 as a bar is illustrated in FIG. 4. As shown therein, the guide track 24 is implemented as a bar, e.g., a metallic bar formed of steel, having the channel 28 formed therein. The channel 28 formed in the guide track 24 defines the first and second members 29a and 29b. The locking mechanism 32 in this implementation may be comprised a threaded rod 46 connecting the handle 30 with a nut 48. The nut 48 may comprise locking pins 50 extending over the guide bar 24 so as to prevent the nut 48 from turning when the user turns the handle 30 in the first or second direction 40 and 42. This implementation shown in FIG. 4 operates substantially as described above wherein the user, turning the handle 30 in the first direction 40 moves the handle assembly 26 to an unlocked configuration (i.e., releases the compression on the first and second members 29a and 29b between the nut 48 and the handle 30), to thereby release the compressive connection between the handle assembly 26 and the guide track 24, and then turns the handle the second direction 42 to a locked configuration (i.e., increases the compression on the first and second members 29a and 29b between the nut 48 and the handle 30), to thereby compressively connect the handle assembly 26 to the guide track 24.

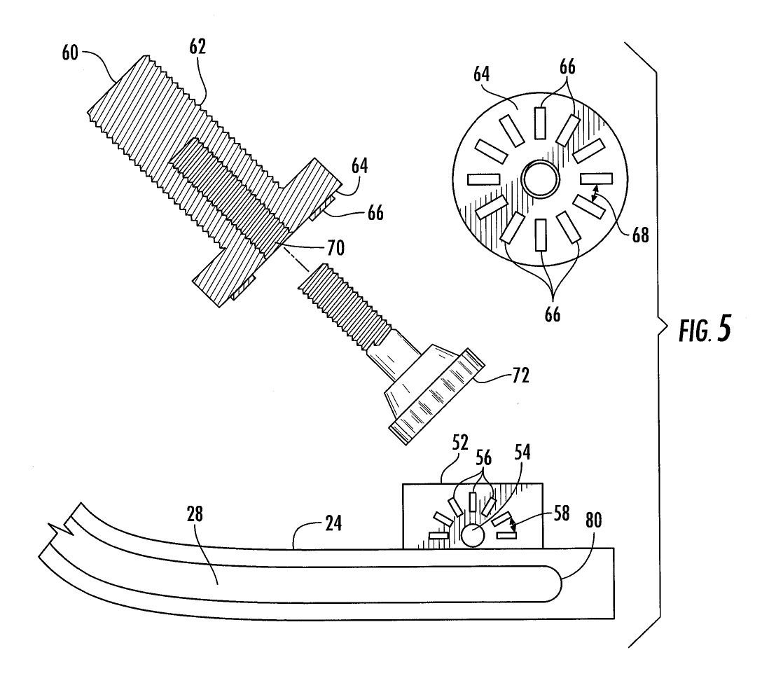

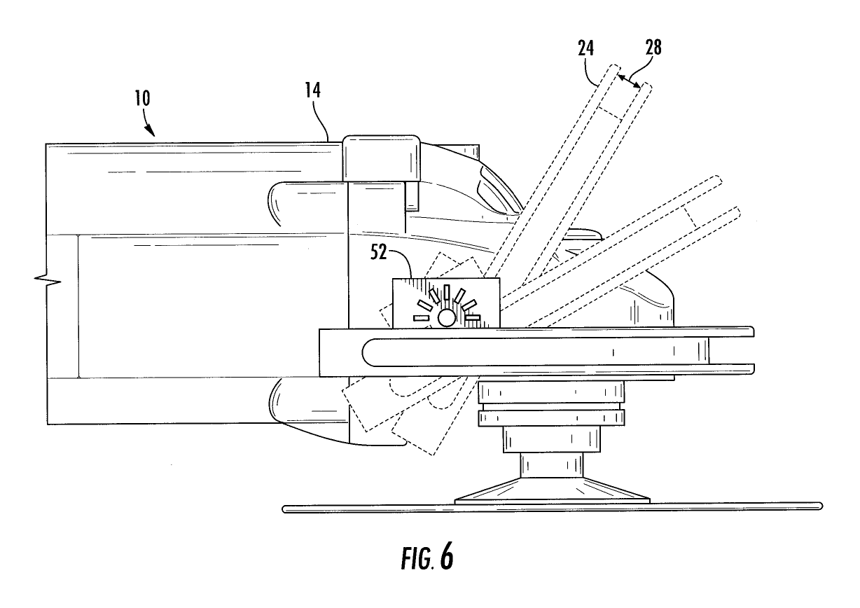

Referring now to FIGS. 5 and 6, shown therein are various aspects of additional features of the adjustable handle assembly 26, in accordance with the present disclosure. The guide track 24 may also be configured to selectively connect to the hand-held tool 10 at a plurality of predetermined angular orientations. The guide track 24 can be connectable to the tool 10 and configured such that it can extend around the front or nose of the head 18 or it can be connected at an angular orientation up and over the top of the head 18. An exemplary configuration adapted to connect the guide track 24 to the hand-held tool 10 at a plurality of predetermined angular orientations can be found with reference to FIG. 5.

As shown in FIG. 5, the guide track 24 may be selectively connectable to the hand-held tool using a mount system (a mount) 50. The mount 50 may comprise a mount plate 52. The mount plate 52 may be integral to the guide track 24. The mount plate 52 may comprise a first aperture 54 and a plurality of second apertures 56 (seven second apertures 56 being shown by way of example in FIG. 5). The second apertures 56 may be positioned at predetermined angles 58 around the first aperture 54. The mount 50 may further comprise a mount base 60. The mount base 60 may be threadably connectable to the hand-held tool 10 (e.g., the mount base 60 may replace the nut 22 discussed above). The mount base 60 may comprise a threaded shaft 62, a mount face 64, and a plurality of extrusions 66 extending from the mount face 64 at predetermined angles 68. The mount base 60 may further comprise an internal aperture 70 extending within at least a portion of the length of the threaded shaft 62. The internal aperture 70 may be threaded. The internal aperture 70 may be used with, for example, a thumb screw 72 to connect the mount plate 52 to the mount base 60 once the base 60 has been connected to the tool 10.

The predetermined angles 58 may correspond to the predetermined angles 68. That is, the extrusions 64 and the second apertures 56 may be correspondingly sized, shaped, and oriented to permit the mount plate 52 to be selectively connected to the mount base 60 (using, for example, the screw 72) at a plurality of predetermined angular orientations with respect to the hand-held tool 10. Although the extrusions 64 and second apertures 56 are illustrated as being rectangular, it is to be understood that the mount 50 may include any number, size, and/or shape of extrusions 64 and corresponding second apertures 56 to provide a positive locking relationship between the mount plate 52 and the mount base 60.

Referring to FIG. 6, illustrated therein is the mount 50 operating to selectively connect the guide track 24 to the tool 10 at a plurality of angular orientations. In operation, the user of the tool 10 would insert into, or otherwise connect the mount base 60 to the tool 10. Then, the user would align the second apertures 56 with the extrusions 66 at a desired angular orientation for the guide track 24. The, the user would secure the mount plate 52 to the mount base 60 using, for example, the thumb screw 72 or other compression fitting (not shown in FIG. 6 so as to illustrate the alignment and connection between the mount plate 52 and the mount base 60) inserted through the first aperture 54 and into the internal aperture 70.

FIGS. 5 and 6 also illustrate another aspect of the present disclosure wherein the channel 28 may not be formed within the entire length of the guide track 24. That is, the guide track 24 may have a length at least longer than the channel length of the channel 28 to thereby define a stop 80. The guide track 24 may include the stop 80 on each end of the guide track 24. The stop 80 may prevent the handle assembly 26 from sliding out of the guide track 24 when in an unlocked configuration.

The embodiments discussed herein are illustrative of the presently disclosed inventive concepts. As these embodiments are described with reference to illustrations, various modifications or adaptations of the methods and/or specific structures described may become apparent to those skilled in the art. All such modifications, adaptations, or variations that rely upon the teachings of the present disclosure, and through which these teachings have advanced the art, are considered to be within the spirit and scope of the present disclosure. Hence, these descriptions and drawings should not be considered in a limiting sense, as it is understood that the present disclosure is in no way limited to only the embodiments illustrated.

What is claimed is:

1. An adjustable handle assembly for a hand-held tool, the assembly comprising:
a guide track connectable to a hand-held tool, the guide track extending around at least a portion of the hand-held tool; and
a handle assembly configured to slidingly associate with the guide track in such a way that the handle assembly is slideably along the guide track when the handle assembly is in an unlocked configuration and prevented from sliding along the guide track when the handle assembly is in a locked configuration.

2. The assembly of claim 1, wherein the guide track is sized and shaped to extend around a head of the hand-held tool.

3. The assembly of claim 1, wherein the guide track further comprises a channel formed therein and having a channel length.

4. The assembly of claim 3, wherein the handle assembly further comprises a locking mechanism configured to extend through the channel to thereby compressively connect the handle assembly to the guide track.

5. The assembly of claim 4, wherein the locking mechanism is configured to slide within the channel and being selectively fixable to any position along the channel length such that the handle assembly can be securely positioned at any angular position around the head of the hand-held tool.

6. The assembly of claim 4, wherein the locking mechanism comprises a bolt connected to a handle of the handle assembly and extending through the channel and a nut threadably connected to the bolt to thereby compressively connect the movable handle assembly to the guide track.

7. The assembly of claim 4, wherein the locking mechanism comprises a threaded insert inside a handle of the handle assembly and a bolt extending through the channel and threadably connected to the threaded insert to thereby compressively connect the movable handle assembly to the guide track.

8. The assembly of claim 1, wherein the guide track is connectable to the hand-held tool using a mount comprising:
a mount plate integral to the guide track, the mount plate including a first aperture and a plurality of second apertures positioned at predetermined angles around the first aperture; and
a mount base threadably connectable to the hand-held tool and having a mount face, the mount base comprising a plurality of extrusions extending from the mount face at predetermined angles, wherein the extrusions and the second apertures are correspondingly sized, shaped, and oriented to permit the mount to be connected to the mount base at a plurality of predetermined angular orientations with respect to the hand-held tool.

9. The assembly of claim 1, wherein the guide track is formed using square tubing comprising a channel formed in a substantially outward facing side of the square tubing with respect to the hand-held tool.

10. The assembly of claim 1, wherein the guide track is formed using a bar and a channel is formed within the bar.

11. An adjustable handle assembly for a hand-held tool, the assembly comprising:
a guide track configured to selectively connect to a hand-held tool at a plurality of predetermined angular orientations, the guide track extending around at least a portion of the hand-held tool; and
a handle assembly configured to slidingly associate with the guide track in such a way that the handle is slideably along the guide track when the handle is in an unlocked configuration and prevented from sliding along the guide track when the handle is in a locked configuration.

12. The assembly of claim 11, wherein the guide track is sized and shaped to extend around a head of a hand-held tool.

13. The assembly of claim 11, wherein the guide track comprises a channel formed therein and having a channel length.

14. The assembly of claim 13, wherein handle assembly further comprises a locking mechanism configured to extend through the channel to thereby compressively connect the handle assembly to the guide track.

15. The assembly of claim 14, wherein the locking mechanism is configured to slide within the channel and being selectively fixable to any position along the channel length such that the handle assembly can be securely positioned at any angular position around the head of the hand-held tool.

16. The assembly of claim 14, wherein the locking mechanism comprises a bolt connected to a handle of the handle assembly and extending through the channel and a nut threadably connected to the bolt to thereby compressively connect the movable handle assembly to the guide track.

17. The assembly of claim 14, wherein the locking mechanism comprises a threaded insert inside a handle of the handle assembly and a bolt extending through the channel and threadably connected to the threaded insert to thereby compressively connect the movable handle assembly to the guide track.

18. The assembly of claim 11, wherein the guide track is selectively connectable to the hand-held tool using a mount comprising:
a mount plate integral to the guide track, the mount plate including a first aperture and a plurality of second apertures positioned at predetermined angles around the first aperture; and
a mount base threadably connectable to the hand-held tool and having a mount face, the mount base comprising a plurality of extrusions extending from the mount face at predetermined angles, wherein the extrusions and the second apertures are correspondingly sized, shaped, and oriented to permit the mount to be connected to the mount base at a plurality of predetermined angular orientations with respect to the hand-held tool.

19. The assembly of claim 8, wherein the guide track is formed using square tubing with the channel formed in a substantially outward facing side of the square tubing with respect to the hand-held tool.

20. A hand-held tool comprising:
a tool housing comprising a head; and
an adjustable handle assembly connected to the tool housing, the adjustable handle assembly comprising;
a guide track extending around at least a portion of the hand-held tool; and
a handle assembly configured to slidingly associate with the guide track in such a way that the handle assembly is selectively fixable to any position along the guide track such that the movable handle assembly can be securely oriented at any angular position around the head of the tool housing.
